(19) United States
(12) Patent Application Publication
(10) Pub. No.: US 2024/0181402 A1
(43) Pub. Date: Jun. 6, 2024

(54) POROUS COMPOSITE MEMBRANE FORMED BY BLENDING PERFLUOROALKOXY ALKANE (PFA) AND ORGANIC MATERIAL, AND MANUFACTURING METHOD THEREOF

(71) Applicant: Pukyong National University Industry-University Cooperation Foundation, Busan (KR)

(72) Inventors: Kie Yong CHO, Busan (KR); Min Young SON, Busan (KR); Young Je KWON, Busan (KR); Jae Won PARK, Busan (KR); Gyeong Min CHOI, Busan (KR)

(73) Assignee: Pukyong National University Industry-University Cooperation Foundation, Busan (KR)

(21) Appl. No.: 18/512,890

(22) Filed: Nov. 17, 2023

(30) Foreign Application Priority Data
Nov. 23, 2022 (KR) 10-2022-0157894

(51) Int. Cl. B01D 69/12; B01D 67/00; B01D 71/34; B01D 71/36; B01D 71/50; B01D 71/52; B01D 71/56

(52) U.S. Cl. CPC B01D 69/12; B01D 67/002; B01D 71/34; B01D 71/36; B01D 71/50; B01D 71/521; B01D 71/56; B01D 2323/42; B01D 2325/02834; B01D 2325/04

(57) ABSTRACT

There are provided a porous composite membrane formed by blending perfluoroalkoxy alkane (PFA) with an organic substance, and a manufacturing method thereof. The porous composite membrane is able to have pores easily formed simply by blending a fluorine-based polymer with an organic substance without additional pore-forming processes such as stretching and heating, and exhibit excellent properties in terms of resistance to high temperatures and strong acids due to the use of the fluorine-based polymer as a base material, so it is available for use in semiconductor wastewater treatment that uses strong acids like HF.

### CROSS—REFERENCE TO RELATED APPLICATION

This Application claims priority to Korean Patent Application No. 10-2022-0157894 (filed on Nov. 23, 2022), which is hereby incorporated by reference in its entirety.

### BACKGROUND

The present invention relates to a porous polymeric composite membrane and a manufacturing method thereof, and more particularly to a porous composite membrane formed by blending perfluoroalkoxy alkane (PFA) with an organic substance, and a manufacturing method thereof.

The water treatment using the membrane technology has evolved in various forms over the past several decades and is now applied in various fields such as wastewater treatment, drinking water purification, wastewater reuse, and desalination. In the semiconductor industry, in particular, it has experienced rapid expansion in scale since industrial development in the 1990s. The industrial water usage has also increased annually, leading the semiconductor industry to become the largest contributor to wastewater discharge as of 2016. Improperly treated wastewater containing high concentrations of fluoride, when discharged into rivers, can have a significant impact on the ecosystem, including microorganisms and fish. Additionally, fluoride, when present in drinking water, can lead to health issues such as vomiting, abdominal pain, diarrhea, and gastrointestinal disorders, as it exists in a dissolved form at high concentrations. When fluoride is released into the atmosphere from fertilizer and metal manufacturing plants, excessive emissions can result in its absorption by plants, potentially causing fluoride poisoning in livestock.

Generally, membranes for water treatment are manufactured using various types of organic polymers and inorganic materials such as ceramics. The polymer materials are most advantageous in the ease of processing, cost-effective, and malleable due to the unique elasticity and tensile properties of polymers, making it easy to manufacture large-area products in desired shapes and sized without breaking or cracking. But, they are relatively disadvantageous in controlling properties such as porosity. On the other hand, the ceramic materials are sturdy but more likely to break or form holes compared to the polymer materials. This makes the ceramic materials less processable, but they are advantageously controllable in porosity with precision.

Currently, the majority of membranes used in water treatment depend on imports, often from Japanese companies. Especially in semiconductor processes, where high temperatures and strong acids like HF are used, there is a need for efficient wastewater treatment technology that performs well even under harsh conditions of strong acids and high temperatures. In this context, research is being conducted with a focus on the fluorine-based polymers to develop membranes with excellent properties in terms of resistance to high temperatures and strong acids for use in water treatment. However, membranes made from a single component of fluorine-based polymer tend to be formed extremely dense, lacking porosity even when stretched, making it challenging to control their porosity properties. Therefore, there is a need for technology to manufacture porous membranes excellent in properties in terms of resistance to high temperatures and strong acids and more effectively usable in water treatment.

### SUMMARY

It is an object of the present invention to provide a polymeric composite membrane that exhibits excellent properties in terms of resistance to high temperatures and strong acids and contains pores formed without additional pore-forming processes, and a manufacturing method for the same.

To achieve the above-mentioned object, the present invention provides a porous composite membrane of which the pores are formed by blending a fluorine-based polymer represented by the following chemical formula 1; and an organic substance,

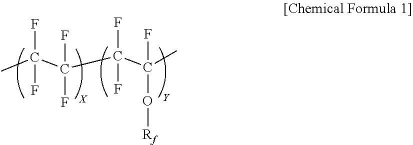

In the chemical formula 1, the ratio of x to y is 20˜70:1, and the R_{f} is selected from perfluorinated groups represented by —CF₂CF₃, —CF₂CF₂CF₃ or —CF(CF₃)₂.

The organic substance may include a fluorine-based polymer having a degradation temperature of 340 to 350 ° C. or above, other than the fluorine-based polymer represented by the chemical formula 1, or an engineering plastic having a degradation temperature of 340 to 350 ° C. or above.

The organic substance may include at least one fluorine-based polymer selected from the group consisting of polyvinylidene fluoride (PVDF), perfluoromethyl alkoxy (MFA), polytetrafluoroethylene (PTFE), and fluorinated ethylene propylene (FEP).

The organic substance may be at least one engineering plastic selected from a polyamide (PA)-based engineering plastic and a polycarbonate (PC)-based engineering plastic.

The fluorine-based polymer and the organic substance may be blended in a weight ratio of 99:1 to 1:99.

The composite membrane may have a porosity of 20% to 60%.

The composite membrane may be used for semiconductor wastewater treatment.

The present invention also provides a method for manufacturing a porous composite membrane that includes: blending a fluorine-based polymer represented by the following chemical formula 1 with an organic substance to prepare a mixture; and melt-extruding and cooling the blended mixture to produce a membrane with pores,

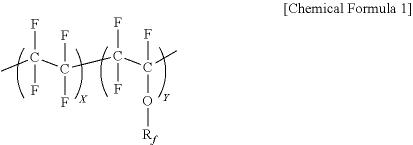

In the chemical formula 1, the ratio of x to y is 20˜70:1, and the R_{f} is selected from perfluorinated groups represented by —CF₂CF₃, —CF₂CF₂CF₃ or —CF(CF₃)₂.

The step of producing a membrane with pores may be performed by melting the mixture in an extruder at a temperature of 340 to 360 ° C. and a screw rotation speed of 20 to 50 rpm, followed by cooling down to room temperature.

The membrane with pores may be formed by extrusion of the mixture at a roller speed of 800 to 1200 mm/min and a take-up roller speed of 30 to 50 mm/min to have an average thickness of 5 to 100 μm.

The pores may have an average diameter of 1 to 1000 nm.

The composite membrane may have a porosity of 20 to 60%.

The porous composite membrane of the present invention can have pores that are easily formed by blending a fluorine-based polymer with an organic substance without additional pore-forming processes such as stretching and heating. This can be achieved by using the difference in properties between the two materials.

The size and distribution of the pores can be controlled by adjusting the types and quantities of the materials.

Furthermore, the porous composite membrane exhibits excellent properties in terms of resistance to high temperatures and strong acids due to the use of the fluorine-based polymer as a base material, so it can be utilized in the treatment of semiconductor wastewater that uses strong acids like HF.

Moreover, the porous membrane can be manufactured under varied process conditions, which leads to advancing the domestic production of separation membranes instead of relying entirely on imported products.

### BRIEF DESCRIPTION OF THE DRAWINGS

FIG. 1 is a schematic diagram showing a process of manufacturing a blend film using a fluorine-based polymer and an organic substance according to one embodiment of the present invention.

FIG. 2 shows PFV blend films with different contents of polyvinylidene fluoride (PVDF) manufactured according to an embodiment of the present invention.

FIG. 3 presents the Fourier-transform infrared spectroscopy (FT-IR) graphs of the PFV blend films of FIG. 2.

FIG. 4 shows the scanning electron microscopy (SEM) images of the PFV films.

FIG. 5 presents the results of a thermal gravimetric analysis (TGA) for the PFV films.

FIG. 6 shows the increase in thermal stability due to the encapsulation effect of the PFV film.

FIG. 7 depicts the pore characteristics of the PFV films. FIG. 8 presents the results of an analysis on the porosity of the PFV films.

FIG. 9 depicts a dead-end-cell system for analysis on the water flux of the PFV films.

FIG. 10 shows the water flux of the PFV films analyzed according to FIG. 9.

FIG. 11 shows PMFA blend films with different contents of perfluoromethyl alkoxysilane (MFA) manufactured according to another embodiment of the present invention.

FIG. 12 presents the FT-IR graphs of the PMFA blend films of FIG. 11.

FIG. 13 presents the TGA results of the PMFA films.

FIG. 14 depicts the pore characteristics of the PMFA films.

FIG. 15 shows composite blend films of PVCT with different contents of polyvinylidene fluoride-co-chlorotrifluoroethylene (PVDF-CTFE) manufactured according to a comparative example of the present invention.

FIG. 16 presents the FT-IR graphs of the PVCT blend films of FIG. 15.

FIG. 17 presents the TGA results of the PVCT films.

### DETAILED DESCRIPTION

Hereinafter, the present invention will be described in detail.

The terminology used in this invention has been selected to reflect widely used common terms, considering the functionality in the context of the present invention. However, these terms may vary depending on the intentions of those skilled in the art, legal precedents, or the emergence of new technologies. Therefore, the terms used in this invention should be defined not merely by their names but based on their meaning and their application throughout the entirety of this invention.

Throughout the specification, unless specified otherwise, the terms “comprises” and/or “comprising” specify the presence of the stated component but do not preclude the presence of one or more other components.

Under the conception that pores can be formed using the difference in properties between a fluorine-based polymer PFA and an organic substance in a PFA-based organic polymeric composite material, the inventors of the present invention have blended PFA with various organic substances to produce porous polymeric composite membranes and found out the fact that the pores can be formed and controlled according to the types and quantities of the organic substances, thereby completing the present invention.

The present invention provides a porous composite membrane in which an organic substance is blended.

More specifically, the invention provides a porous composite membrane in which pores are formed by blending a fluorine-based polymer represented by the following chemical formula 1; and an organic substance,

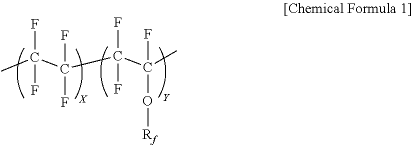

In the chemical formula 1, the ratio of x to y may be 20˜70:1, and the R_{f} may be selected from C2-C4 perfluorinated groups.

Preferably, the ratio of x to y may be 25˜30:1, and more preferably 27˜29:1, but is not limited thereto.

Preferably, the R_{f} may be selected from perfluorinated groups represented by —CF₂CF₃, —CF₂CF₂CF₃ or —CF(CF₃)₂, but is not limited thereto.

In this specification, the term “perfluoro/perfluorinated group” refers to a radical having a molecular chain in which C—H is all replaced by C—F.

Preferably, the fluorine-based polymer may be a perfluoroalkoxy alkane (PFA), as a copolymer of tetrafluoroethylene (TFE) and perfluoroalkyl vinyl ether (PAVE), but is not limited thereto.

The PFA is a fluorine-based resin that is excellent in melt flowability with good characteristics of polytetrafluoroethylene (PTFE) and capable of being melt-molded by injection molding or extrusion molding as a thermoplastic resin.

The organic substance is a polymer with a degradation temperature higher than the processing temperature of the fluorine-based polymer. It may include a fluorine-based polymer having a degradation temperature of 340 to 350° C. or above, other than the fluorine-based polymer represented by the chemical formula 1, or an engineering plastic having a degradation temperature of 340 to 350° C. or above.

Preferably, the organic substance may include, but is not limited to, at least one fluorine-based polymer selected from the group consisting of polyvinylidene fluoride (PVDF), perfluoromethyl alkoxy (MFA), polytetrafluoroethylene (PTFE), and fluorinated ethylene propylene (FEP).

Preferably, the organic substance may include, but is not limited to, at least one engineering plastic selected from a polyamide (PA)-based engineering plastic or a polycarbonate (PC)-based engineering plastic.

The fluorine-based polymer and the organic substance may be blended in a weight ratio of 99:1 to 1:99. Depending on the weight ratio, the fluorine-based polymer acts as a matrix and the organic substance acts as a filler; or the organic substance acts as a filler and the fluorine-based polymer acts as a matrix. It is possible to provide a porous composite membrane with pores formed by the blending step. In this regard, the average diameter of the pores ranges from 1 nm to 1000 nm, preferably 10 nm to 100 nm, but is not limited thereto.

The weight ratio may be adjusted based on the type of the organic substance and the size and distribution of the pores to be formed.

According to one experimental example of the present invention, using polyvinylidene fluoride (PVDF) as the organic substance, pores were formed uniformly in an average diameter of 10 to 20 nm when using a blend of PFA and PVDF in a weight ratio of 85:15, and in an average diameter of 60 to 70 nm when using a blend of PFA and PVDF in a weight ratio of 80:20. This revealed the fact that the type and quantity of the material can be adjusted to acquire a desired pore size.

In addition, the porous composite membrane may have a porosity of 20 to 60%, preferably 40 to 50%, but is not limited thereto.

The porous composite membrane having porosity within the defined range exhibits excellent water flux and is suitable for use as a separation membrane for water treatment.

The composite membrane, which has the advantage of being usable under conditions of high temperatures and strong acids, is available for semiconductor wastewater treatment, but is not limited thereto.

The present invention also provides a method for manufacturing a porous composite membrane in which an organic substance is blended.

More specifically, the present invention provides a method for manufacturing a porous composite membrane that includes: blending a fluorine-based polymer represented by the following chemical formula 1 with an organic substance to prepare a mixture; and melt-extruding and cooling the blended mixture to produce a membrane with pores,

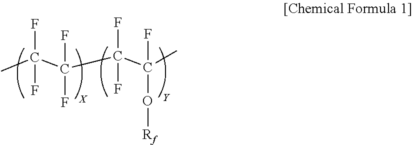

In the chemical formula 1, the ratio of x to y may be 20˜70:1, and the R_{f} may be selected from C2-C4 perfluorinated groups.

Preferably, the ratio of x to y may be 25˜30:1, and more preferably 27˜29:1, but is not limited thereto.

Preferably, the R_{f} may be selected from perfluorinated groups represented by —CF₂CF₃, —CF₂CF₂CF₃ or —CF(CF₃)₂, but is not limited thereto.

The step of blending a fluorine-based polymer with an organic substance to prepare a mixture is mixing the fluorine-based polymer and the organic substance in a weight ratio of 99:1 to 1:99.

The organic substance may include a fluorine-based polymer having a degradation temperature of 340 to 350° C. or above, other than the fluorine-based polymer represented by the chemical formula 1, or an engineering plastic having a degradation temperature of 340 to 350° C. or above.

Preferably, the organic substance may be at least one fluorine-based polymer selected from the group consisting of polyvinylidene fluoride (PVDF), perfluoromethyl alkoxy (MFA), polytetrafluoroethylene (PTFE), and fluorinated ethylene propylene (FEP), but it not limited thereto.

Preferably, the organic substance may be at least one engineering plastic selected from a polyamide (PA)-based engineering plastic or a polycarbonate (PC)-based engineering plastic, but is not limited thereto.

The step of producing a membrane with pores is melt-extruding and cooling down the blended mixture.

Preferably, the membrane with pores may be produced by melting the mixture in an extruder at a temperature of 340 to 360° C. and a screw rotation speed of 20 to 50 rpm and then cooling it down to room temperature. Below the temperature and rotation speed ranges, the fluorine-based polymer pellets do not melt enough to blend properly, or the molten polymer cools down too quickly to be adequately extruded. It is therefore desirable to perform the step in the above-defined temperature and rotation speed ranges.

The membrane with pores may be formed by extrusion of the mixture at a roller speed of 800 to 1200 mm/min and a take-up roller speed of 30 to 50 mm/min into a membrane with an average thickness of 5 to 100 μm, but is not limited thereto. The pores may have an average diameter of 1 to 1000 nm and a porosity of 20 to 60%, but is not limited thereto.

Equivalent characteristics can be substituted for those described in the above sections.

Hereinafter, the disclosure of the present invention will be described in further detail with reference to examples, which are given for the understanding of the disclosure of the present invention and not intended to limit the scope of the present invention. The examples of the present invention are provided to more fully explain the present invention to those skilled in the art.

### EXAMPLE 1

### l Selection of Organic Composite Material

In order to manufacture a composite blend film based on perfluoroalkoxy alkane (PFA), it is necessary to secure thermal stability at temperatures higher than the processing temperature of PFA. Generally, the processing temperature of PFA is at least 310° C. or higher. Hence, a temperature of 340-350° C. or higher is required to create a film with suitable extrusion and no defects such as tearing during the manufacturing process. Therefore, the substances that can be used for organic composite materials are to be those not degradable at temperatures of 350° C. or higher.

Table 1 below shows the degradation temperatures of various materials for selecting organic composite materials.

TABLE 1

| | Degradation | | Degradation | | Degradation |
|---|---|---|---|---|---|
| Fluorine based | Temperature | Engineering | Temperature | Common | Temperature |
| Polymer | (° C.) | Plastic | (° C.) | Polymer | (° C.) |
| PVDF | 365~400 | PA | 420~520 | PE | 335 |
| PVDF-CTFE | 340 | PMMA | 180~350, | PP | 300 |
| MFA | 520 | | 350~400 | PVC | 200~300 |
| PFA | 500 | PBT | 350~450 | PET | 280~300 |
| PTFE | 500~550 | POM | 250 | PS | 325~375 |
| PVF | 320 | PC | 420~600 | | |
| FEP | 450 | | | | |

When categorizing organic composite materials into fluorine-based polymers, engineering plastics, and commonly used general-purpose polymers, the fluorine-based polymers are very excellent in thermal stability. The most of the fluorine-based polymers other than polyvinylidenedifluoride-co-chlorotrifluoroethylene (PVDF-CTFE) and polyvinylfluoride (PVF) are suitable for use as composite materials due to their degradation temperatures higher than the degradation temperature of PFA, as indicated in Table 1.

As for the engineering plastics, polyamide (PA)-based engineering plastics and polycarbonate (PC)-based engineering plastics are considered available in the manufacture of PFA-based blend films because of their degradation temperatures are 420° C. or above. In contrast, the general-purpose polymers are mostly considered unavailable in the manufacture of blend films due to their degradation temperatures lower than the processing temperature of PFA.

Table 2 below presents the temperature characteristics of the fluorine-based polymers and the engineering plastics.

TABLE 2

| | | | | Degration |
|---|---|---|---|---|
| | | | | Temperature |
| Type | Name | T_{g} (° C.) | Tₘ (° C.) | (° C.) |
| Fluorine | PVDF | −35 | 177 | 365~400 |
| based | MFA | — | 285 | 520 |
| Polymer | PFA | 250 | 300 | 500 |
| | PTFE | 119 | 327 | 500~550 |
| | FEP | | 275 | 450 |
| Engineering | PA | 120~150 | 260~300 | 420~520 |
| Polymer | PC | 145~150 | 215~230 | 420~600 |

It is general to select materials excellent in flowability for use in the melt extrusion process. The flowability of most polymers tends to improve with an increase in the temperature because the molecular activity increases in proportion to the temperature.

The glass transition temperature (T_{g}) refers to the temperature at which polymer chains begin to move gradually and is generally considered as a temperature suitable for the start of processing. The materials with the lower glass transition temperature (T_{g}) are considered more processable. Similarly, the composite materials with the lower melting temperature (Tₘ) are more excellent in flowability at the processing temperature of PFA and more suitable for melt extrusion.

### EXAMPLE 2

### Production of Composite PFV Blend Film Using Fluorine-Based Polymer PFA and Organic Composite Material PVDF

Mixtures were prepared by blending perfluoroalkoxy alkanes (PFA, made by Daikin, Daikin AP-201) as a base material with polyvinylidene fluoride (PVDF, made by Solef) as a polymer filler. In general containers, PFA pellets and PVDF powder were uniformly mixed in weight (wt %) ratios of 97.5:2.5, 95:5, 90:10, 85:15, 80:20, and 70:30. According to the content (wt. %) of PVDF, the mixtures thus obtained were denoted as PFV 2.5, PFV 5, PFV 10, PFV 15, PFV 20, and PFV 30, respectively.

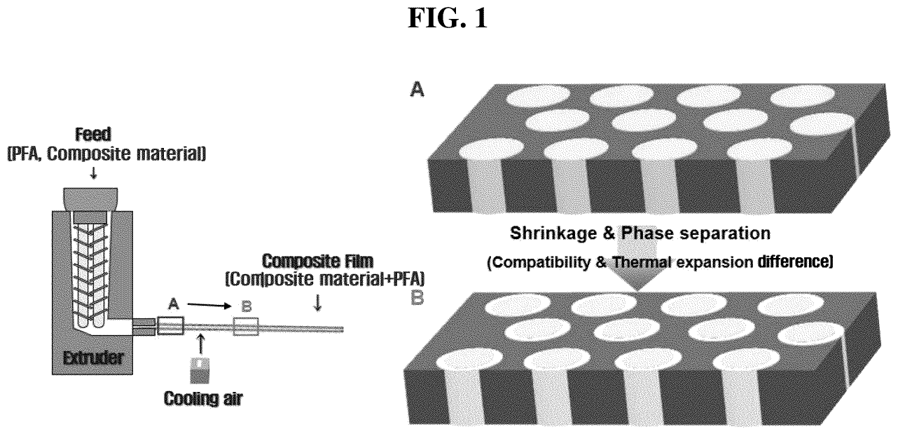

Each uniform mixture of PFV was fed into the automatic feeding system of a melt extruder and extruded into a composite blend film at extruder and T-die temperatures of 340° C., a Screw rotation speed of 25 rpm, a roller speed of 1000 mm/min, and a take-up roller speed of 40 mm/min (FIG. 1). The thickness of the film was determined according to the take-up roller speed, and a sample was prepared in size of about 50 μm.

The temperature of the polymer melt extruded in the equipment was approximately 350° C. The moment the polymer melt left the equipment, its temperature dramatically dropped to the room temperature (about 25° C.) to complete a cooling process. In addition, cooling air was applied to the film at a pressure of about 0.3 to 1 bar to promote heat equilibrium.

### EXAMPLE 3

### Production of Composite PMFA Blend Film Using Fluorine-based Polymer PFA and Organic Composite Material MFA

The procedures were performed in the same manner as described in Example 2, excepting that PFA and perfluoromethyl alkoxy (MFA) were used to produce a composite PMFA blend film.

Unlike the PVDF powder, MFA were provided in the form of pellets. In general containers, PFA and MFA pellets were uniformly mixed in weight (wt %) ratios of 0:100, 90:10, 80:20, 70:30, 20:80, and 10:90. According to the content (wt %) of MFA, the mixtures thus obtained were denoted as MFA, PMFA 10, PMFA 20, PMFA 30, PMFA 80, and PMFA 90, respectively.

Each uniform mixture of MFA and PMFA was fed into the automatic feeding system of a melt extruder and extruded into a composite blend film at extruder and T-die temperatures of 340° C. and 350° C., respectively, a Screw rotation speed of 25 rpm, a roller speed of 1000 mm/min, and a take-up roller speed of 40 mm/min, following by cooling down to the room temperature. The thickness of the film was determined according to the take-up roller speed, and a sample was prepared in size of about 50 μm.

### Comparative Example 1 Production of Composite PVCT Blend Film Using Fluorine-Based Polymer PFA and Organic Composite Material PVDF-CTFE

The procedures were performed in the same manner as described in Example 2, excepting that PFA and polyvinylidenedifluoride-co-chlorotrifluoroethylene (PVDF-CTFE) were used to produce a composite PVCT blend film.

PFA pellets and PVDF-CTFE were uniformly mixed according to the weight (wt %) ratio. The PVCT weight ratio was determined according to each PVDF-CTFE content (wt. %).

Each uniform mixture of PVCT was fed into the automatic feeding system of a melt extruder and extruded into a composite blend film at extruder and T-die temperatures of 340° C., a Screw rotation speed of 25 rpm, a roller speed of 1000 mm/min, and a take-up roller speed of 40 mm/min, following by cooling down to the room temperature. The thickness of the film was determined according to the take-up roller speed, and a sample was prepared in size of about 50 μm.

### Experiment 1 Analysis of PFV Blend Film

### 1-1. Property Analysis of PFV

The properties of the blend films prepared in Example 2 were analyzed.

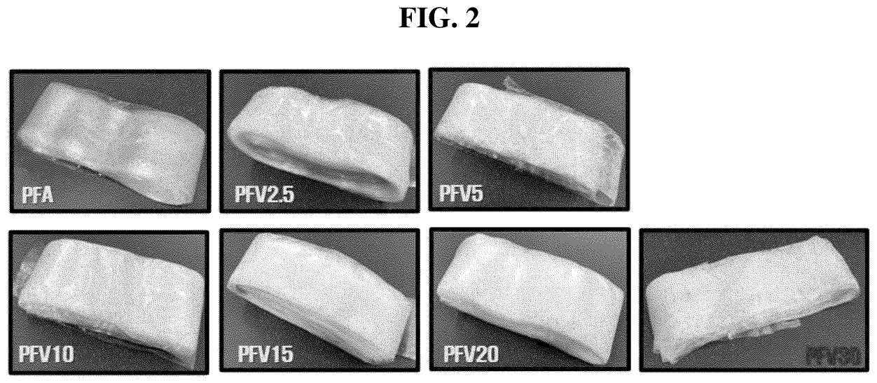

Referring to FIG. 2, the PFV blend films were formed with different PVDF contents, but PFV 30, containing 30 wt. % of PVDF, had some defects due to partial degradation of PVDF.

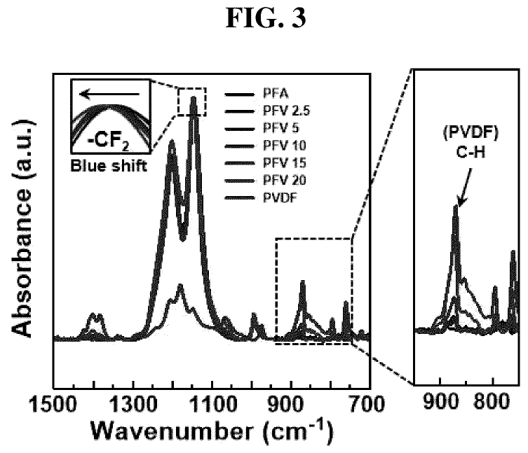

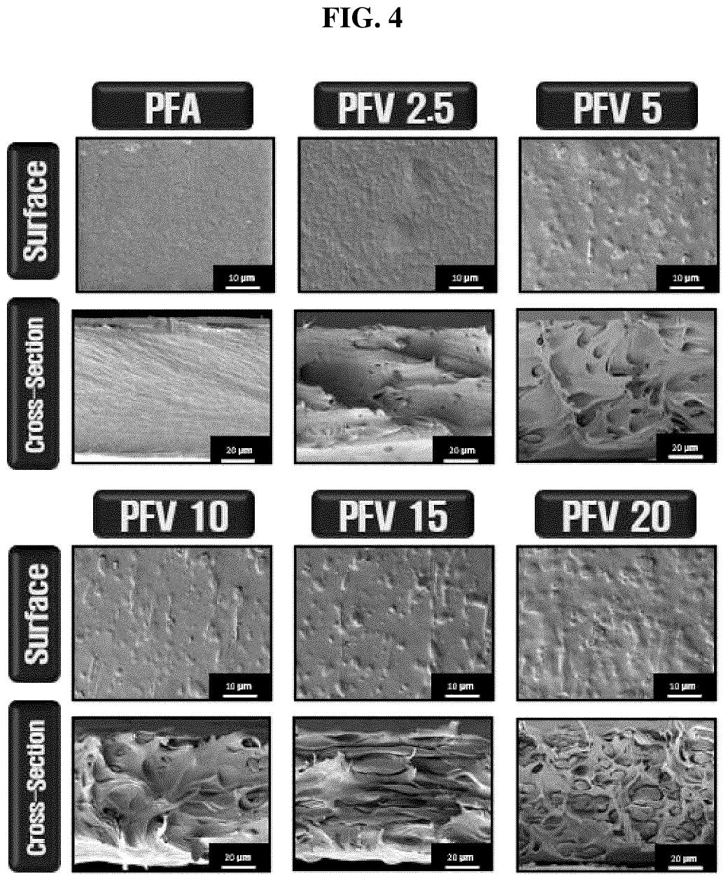

To confirm the uniform mixing of PFA and PVDF, as shown in FIG. 3, the C-H peak of PVDF in each blend film increased at around 900 cm⁻¹ in the Fourier-transform infrared spectroscopy (FT-IR) analysis. Referring to FIG. 4, the spherical parts in the scanning electron microscope (SEM) images correspond to the PVDF particles, further confirming an increase in the PVDF content of the blend films.

The thermal stability of each blend film was measured using the thermogravimetric analysis (TGA) at 30 to 800° C., a heating rate of 10° C./min and an N2 flow rate of 30 cc/min.

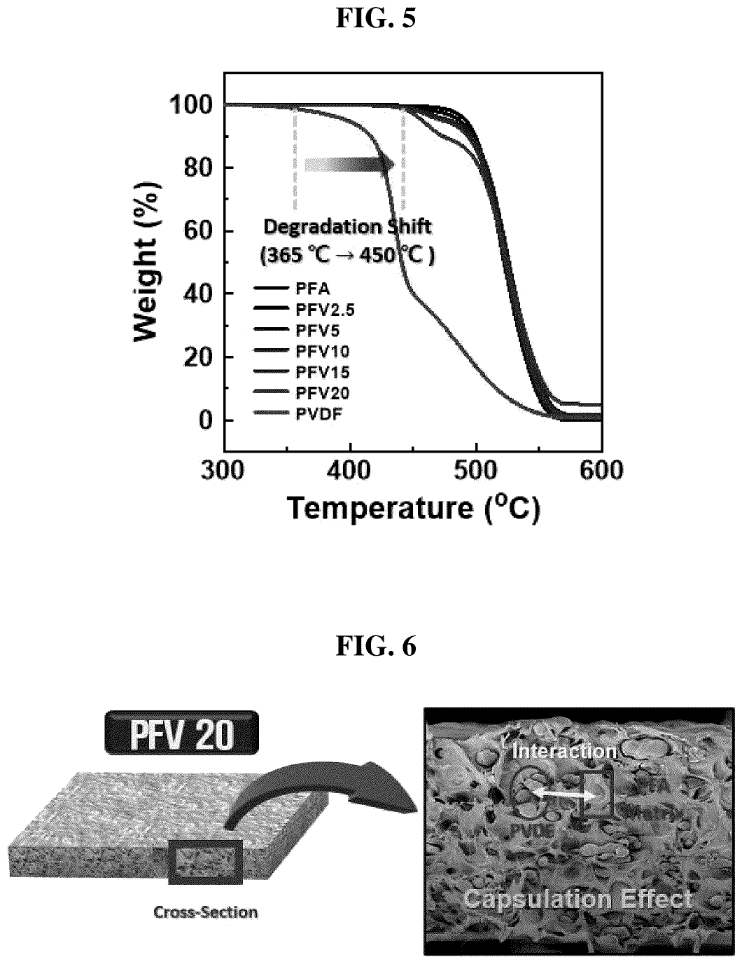

As shown in FIG. 5, the degradation temperature shifted from 365° C. to 450° C. While the original PVDF had a degradation temperature of about 365° C., the blend films exhibited a delayed degradation of PVDF due to the PFA with high thermal stability encapsulating the PVDF. This encapsulation presumably resulted from the PFA matrix effectively encapsulating the PVDF composite material, as depicted in FIG. 6, to delay the degradation temperature due to the interaction between PFA and PVDF.

### 1-2. Analysis on Pore Characteristics and Water Flux of PFV

Referring to FIG. 1, substances with similar properties, likely to agglomerate, expanded at high temperatures (340˜350° C.) in the extruder and contracted with a cooling air in the subsequent cooling process, potentially creating pores between PFA used as a base material and the organic substance.

A porometer was used to measure the porosity of each blend film produced according to Example 2, determining the pore characteristics of the blend film as a function of the contents. The measurements were conducted using a galwick solution according to the wet-up/dry-up method.

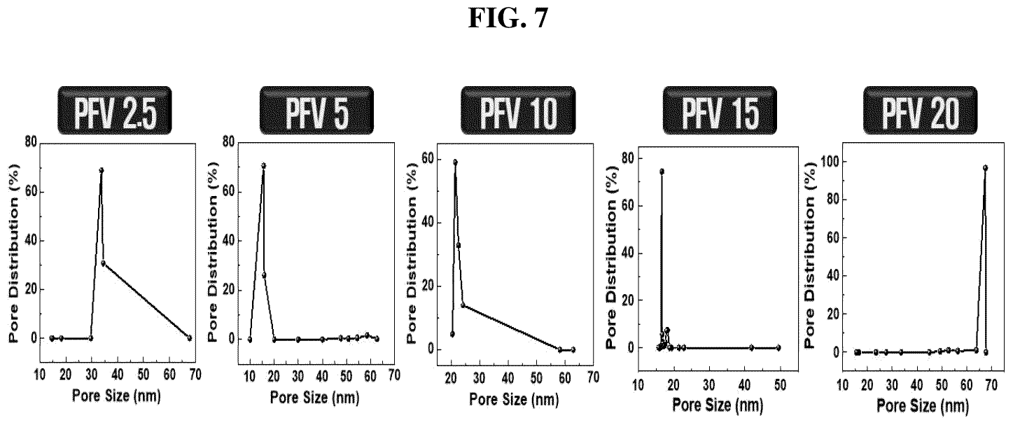

As shown in FIG. 7, the pore size distribution was dependent upon the PVDF content. It was desirable for a film to have pores in a constant size resulting from the uniform distribution of PVDF. Taking the ease of adjustment for the subsequent processing into consideration, the PFV 15 with distribution of a nearly identical pore size was considered as the most suitable film.

In addition, based on the conventional experiments indicating the PFV blend film not absorbing water, the porosity was measured by weighing the blend film and placing it in a mass cylinder to determine the change in volume.

Weight/Volume Change=Density of Blend Film <Equation 1>

The theoretical and experimental densities of PFV based on the contents and densities of PFA and PVDF are presented in Table 3. The difference between the theoretical and experimental densities was used to determine the porosity (FIG. 8).

TABLE 3

| | | Content | | |
|---|---|---|---|---|
| | | (wt. %) | Theoretical | Experimental |
| PFA | PVDF | ratio | density | density |
| density | density | (PFA:PVDF) | (g/cm³) | (g/cm³) |
| 2.15 g/cm³ | 1.78 g/cm³ | 97.5:2.5 | 2.14 | 1.512 |
| | | 95:5 | 2.13 | 1.49 |
| | | 90:10 | 2.11 | 1.34 |
| | | 85:15 | 2.09 | 1.095 |
| | | 80:20 | 2.07 | 1.396 |

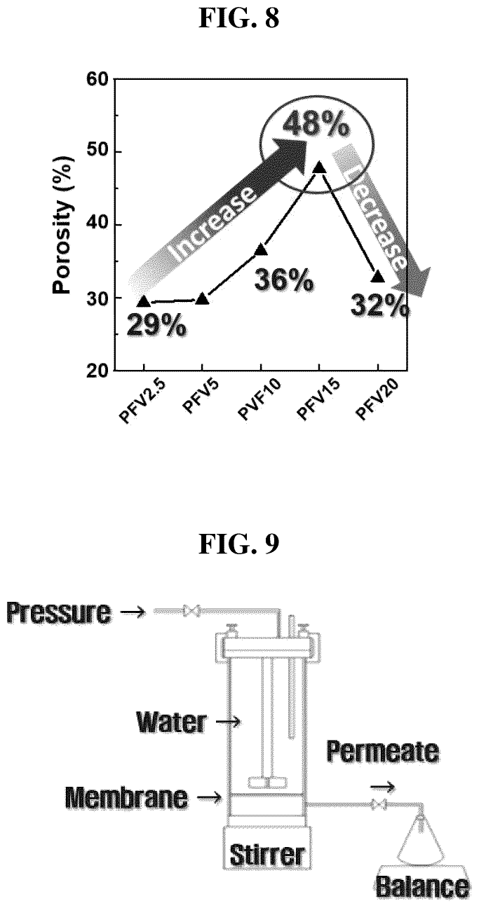

The water flux was measured using the dead-end-cell system of FIG. 9 under the following conditions:
Pressure: 1 bar
Duration: 15 to 24 hours
Film thickness: 50 μm
Film surface area: 0.0017 m²

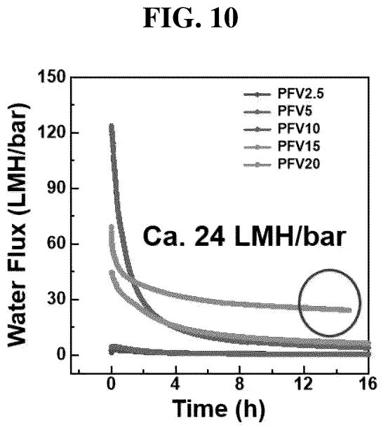

As shown in FIG. 10, where the water flux was measured for 8 hours or longer, the PFV 15 film had the highest water flux in a steady manner; the PFV 20 film had the second-highest water flux despite the larger pore size and the lower porosity in comparison to the PFV 10 film; and the PFV 2.5 and PFV 5 films displayed a relatively low water flux due to the porosity of about 29%.

Referring to the porosity of FIG. 8 as discussed earlier, the porosity increased with an increase in the PVDF content in the films up to PFV 15 and decreased in the PFV 20 film, suggesting that the water flux is related to the porosity rather than the pore size.

In conclusion, the PFV 15 film showed the narrowest pore distribution in the concepts of pore control and pore formation and contained the largest number of pores.

This analysis on the porosity and water flux can be applied in the same manner to the complex PMFA blend films according to other examples.

### Experimental Example 2 Analysis of PMFA Blend Film

### 2-1. Property Analysis of PMFA

The blend films prepared in Example 3 were analyzed in terms of characteristics.

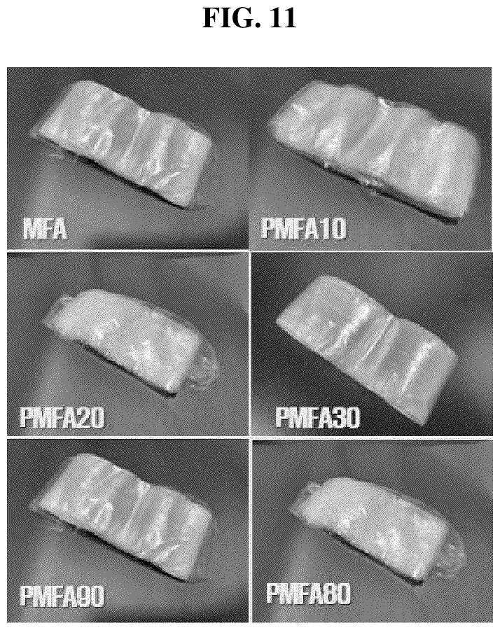

Referring to FIG. 11, MFA, similar in properties to PFA, is available just alone for use in forming a film, possibly in a weight ratio of PFA to MFA ranging from 100:0 to 0:100.

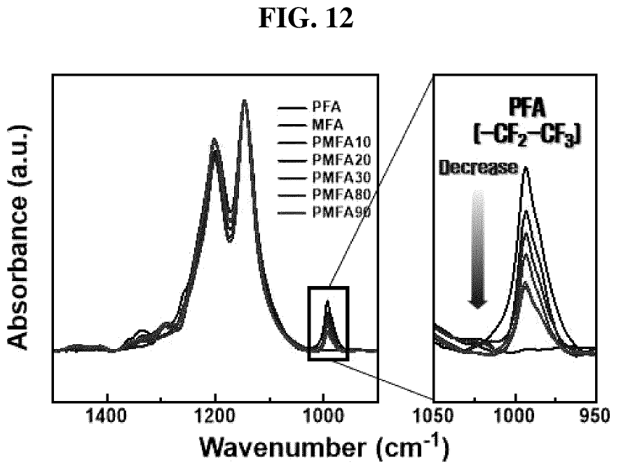

Referring to FIG. 12, the FT-IR analysis shows a gradual decrease in the absorbance peak for CF₂—CF₂—CF₃ in R_{f} of PFA, indicating a gradual increase in the MFA content.

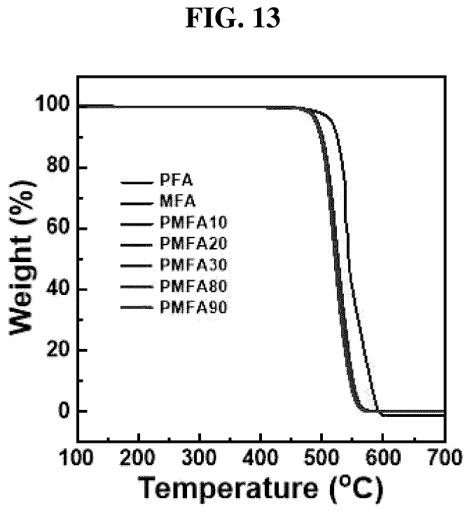

The thermal stability of each blend film was measured using the thermogravimetric analysis (TGA) at temperatures of 30 to 800° C., a heating rate of 10° C./min and an N₂ flow rate of 30 cc/min. As shown in FIG. 13, the film had a degradation temperature of about 500° C. as similar to PFA, thereby considered as having a high thermal stability.

### 2-2. Analysis on Pore Characteristics of PMFA

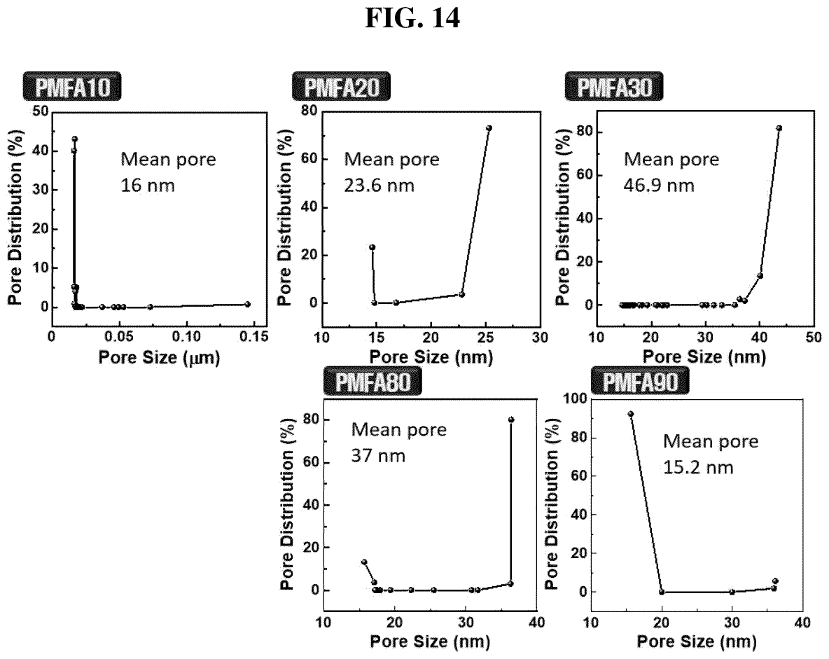

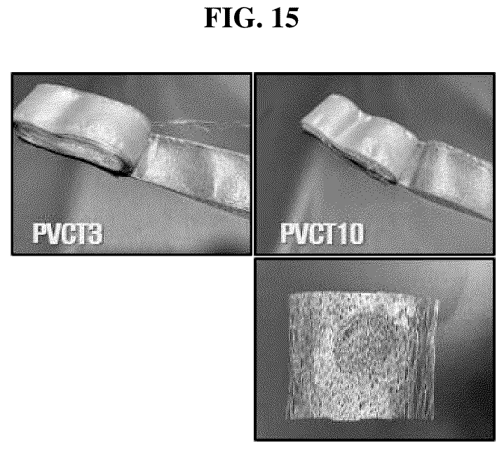

A single-component film of PFA or MFA turned out non-porous (dense), that is, pore-free. Although porous films with all the different contents were not made, the contents were adjusted to manufacture films porous films with all the different contents, the contents were adjusted to produce films having a dominant content of PFA (e.g., PMFA 10, PMFA 20 and PMFA 30) and films having a dominant content of MFA (e.g., PMFA 80 and PMFA 90). According to the measurements of the pore size based on the content, as shown in FIG. 14, in PMFA 10, PMFA 20, and PMFA 30 containing PFA primarily used as a matrix, MFA acted as a composite material and thus the average pore size increased with an increase in the content of MFA. Conversely, in PMFA 80 and PMFA 90 containing MFA primarily used as a matrix, PFA acted as a composite material and the average pore size increased with an increase in the content of PFA. In other words, this case had an advantage that not only PFA is used as the matrix, but MFA can also be used as the matrix.

### Experimental Example 3 Analysis of PVCT Blend Film

The characteristics of the blend films manufactured in Comparative Example 1 were analyzed.

The PVDF-CTFE samples have stability issues due to their degradation temperatures lower than the processing temperature of PFA, as shown in Table 1. Like the samples of Examples 2 and 3, the samples prepared using the uniform mixture of 10 wt. % of PVDF-CTFE and 90 wt. % of PFA under the above-defined conditions failed to form membranes due to burning of the films, as shown in FIG. 15. Although the content of PVDF-CTFE was reduced to 3 wt. %, films were not formed properly but burnt out.

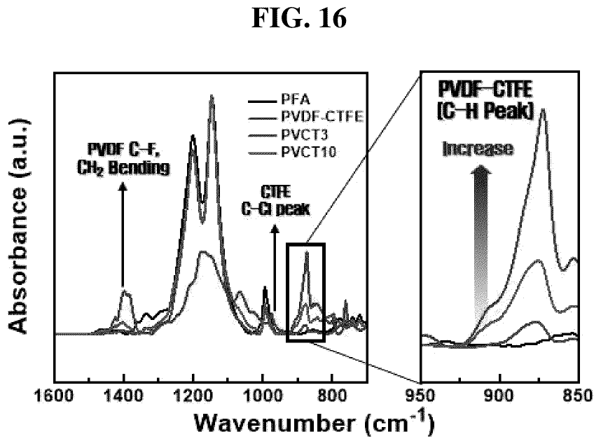

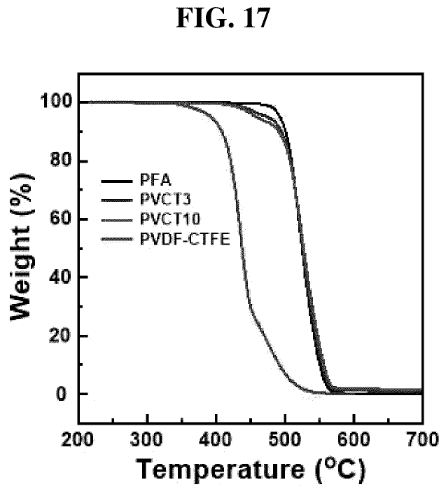

According to the FT-IR analysis for the generated blend films, there was a tendency of the C—H and C—Cl peaks for PVDF-CTFE increasing as shown in FIG. 16. However, according to the TGA, as shown in FIG. 17, the degradation temperature of PVDF-CTFE was around 330° C., suggesting that the PVDF-CTFE samples were not suitable for use in the manufacture of films, resulting in improper formation of blend films.

The foregoing description has been given as to the specific examples of the present invention. It should be apparent to those skilled in the art that the present invention can be implemented in modified forms within the scope of the present invention. Therefore, the disclosed examples are to be construed as merely illustrative, and not limitative of the present invention. The scope of the present invention is not defined by the appended claims rather than by the description of the present invention, and all the differences within the equivalent scope of the present invention should be interpreted as included in the present invention.

What is claimed is:

1. A porous composite membrane with pores, which are formed by blending a fluorine-based polymer represented by the following chemical formula 1; and an organic substance, 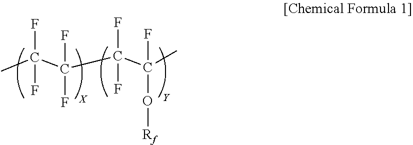
wherein the ratio of x to y is 20˜70:1, and the R_{f} is selected from perfluorinated groups represented by —CF₂CF₃, —CF₂CF₂CF₃ or —CF(CF₃)₂.

2. The porous composite membrane according to claim 1, wherein the organic substance comprises a fluorine-based polymer having a degradation temperature of 340 to 350° C. or above, other than the fluorine-based polymer represented by the chemical formula 1, or an engineering plastic having a degradation temperature of 340 to 350° C. or above.

3. The porous composite membrane according to claim 1, wherein the organic substance is at least one fluorine-based polymer selected from the group consisting of polyvinylidene fluoride (PVDF), perfluoromethyl alkoxy (MFA), polytetrafluoroethylene (PTFE), and fluorinated ethylene propylene (FEP).

4. The porous composite membrane according to claim 1, wherein the organic substance is at least one engineering plastic selected from a polyamide (PA)-based engineering plastic and a polycarbonate (PC)-based engineering plastic.

5. The porous composite membrane according to claim 1, wherein the fluorine-based polymer and the organic substance are blended in a weight ratio of 99:1 to 1:99.

6. The porous composite membrane according to claim 1, wherein the composite membrane has a porosity of 20% to 60%.

7. The porous composite membrane according to claim 1, wherein the composite membrane is used for semiconductor wastewater treatment.

8. A method for manufacturing a porous composite membrane, comprising:
blending a fluorine-based polymer represented by the following chemical formula 1 with an organic substance to prepare a mixture; and
melt-extruding and cooling the blended mixture to produce a membrane with pores, 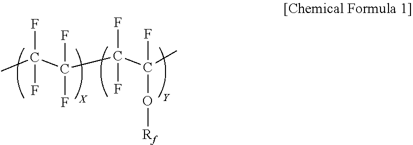
wherein the ratio of x to y is 20˜70:1, and the R_{f} is selected from perfluorinated groups represented by —CF₂CF₃, —CF₂CF₂CF₃ or —CF(CF₃)₂.

9. The method according to claim 8, wherein the step of producing a membrane with pores is performed by melting the mixture in an extruder at a temperature of 340 to 360° C. and a screw rotation speed of 20 to 50 rpm, followed by cooling down to room temperature.

10. The method according to claim 8, wherein the membrane with pores is formed by extrusion of the mixture at a roller speed of 800 to 1200 mm/min and a take-up roller speed of 30 to 50 mm/min into a membrane with an average thickness of 5 to 100 μm.

11. The method according to claim 8, wherein the pores have an average diameter of 1 to 1000 nm.

12. The method according to claim 8, wherein the composite membrane has a porosity of 20 to 60%.
